(19) United States
(12) Patent Application Publication
(10) Pub. No.: US 2013/0311226 A1
(43) Pub. Date: Nov. 21, 2013

(54) SYSTEM AND METHOD TO ESTIMATE RESOURCE ALLOCATIONS FOR A PROJECT

(71) Applicant: Linda Lee Dreselly, Coventry, CT (US)

(72) Inventor: Linda Lee Dreselly, Coventry, CT (US)

(21) Appl. No.: 13/471,664

(22) Filed: May 15, 2012

(51) Int. Cl. G06Q 10/06

(52) U.S. Cl. 705/7.23

(57) ABSTRACT

According to some embodiments, a resource estimation tool may be provided for a project, such as a complex financial services project, to be performed in a series of project phases. Initially, a set of pre-determined tasks for the project may be automatically determined, each task being associated with one or more of the project phases. Moreover, a default estimated resource allocation value may be assigned to each task in connection with each project phase. According to some embodiments, a project size input may be received, and a spreadsheet application formula may automatically adjust the default estimated resource allocation values associated with all tasks based on the project size input. An overall project resource allocation estimate may then be output based on the adjusted default estimated resource allocation values for all tasks across all project phases.

### BACKGROUND

In some cases, an amount of resources associated with business project may need to be estimated. Consider, for example, an enterprise that is considering updating and improving an existing system. In this case, a project leader might be asked to estimate how many work hours would be required to implement the update. Such information might be useful, for example, to help the enterprise perform a cost versus benefit analysis to determine whether or not the update should be implemented in view of the investment required.

Typically, the project leader might make such an estimation based on prior projects he or she has worked on. In addition, the project leader might break the project into a set of sub-projects to improve the accuracy of the estimation. Performing such steps, however, can be a time-consuming and error prone process.

Note that projects, and specifically Information Technology related projects in the financial services/insurance, are exceptionally complex due to the required involvement of various business, compliance and legal stakeholders. With projects involving insurance policies, claims and policyholders, various regulatory, business and legal requirements need to be coordinated and managed to ensure compliance across all these areas. For example, processing of data in these financial services/insurance projects may require compliance with certain protocols and procedures for the handling of sensitive claim, health and personally identifiable information and, as a result, can be difficult and costly to update.

It would therefore be desirable to provide systems and methods to facilitate resource allocation estimations for a project in an automated, efficient, and accurate manner.

### SUMMARY OF THE INVENTION

According to some embodiments, systems, methods, apparatus, computer program code and means may provide a resource estimation tool for a project to be performed in a series of project phases. Initially, a set of pre-determined tasks for the project may be automatically determined, each task being associated with one or more of the project phases. Moreover, a default estimated resource allocation value may be assigned to each task in connection with each project phase. According to some embodiments, a project size input may be received, and a spreadsheet application formula may automatically adjust the default estimated resource allocation values associated with all tasks based on the project size input. An overall project resource allocation estimate may then be output based on the adjusted default estimated resource allocation values for all tasks across all project phases.

Some embodiments provide: means for automatically determining a set of pre-determined tasks for the project, each task being associated with one or more of the project phases; means for assigning a default estimated resource allocation value to each task in connection with each project phase; means for receiving a project size input; means for adjusting, by a spreadsheet application formula, the default estimated resource allocation values associated with all tasks based on the project size input; and means for outputting an overall project resource allocation estimate based on the adjusted default estimated resource allocation values for all tasks across all project phases.

A technical effect of some embodiments of the invention is an improved and computerized method of providing a resource allocation estimate for a business project. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a business project according to some embodiments of the present invention.

FIG. 2 is block diagram of a system according to some embodiments of the present invention.

FIG. 3 illustrates a method according to some embodiments of the present invention.

FIG. 4 illustrates a project resource allocation estimate according to some embodiments of the present invention.

FIG. 5 illustrates a project resource allocation estimate for a large sized project according to some embodiments of the present invention.

FIG. 6 illustrates a project resource allocation estimate including indications as to whether each task will need to be performed according to some embodiments of the present invention.

FIG. 7 illustrates a project resource allocation estimate including a task complexity feature according to some embodiments of the present invention.

FIG. 8 illustrates a project resource allocation estimate including an override feature according to some embodiments of the present invention.

FIG. 9 is block diagram of a resource allocation estimation tool according to some embodiments of the present invention.

FIG. 10 is a tabular portion of a customer interaction database according to some embodiments.

FIG. 11 illustrates a display in accordance with some embodiments described herein.

### DESCRIPTION

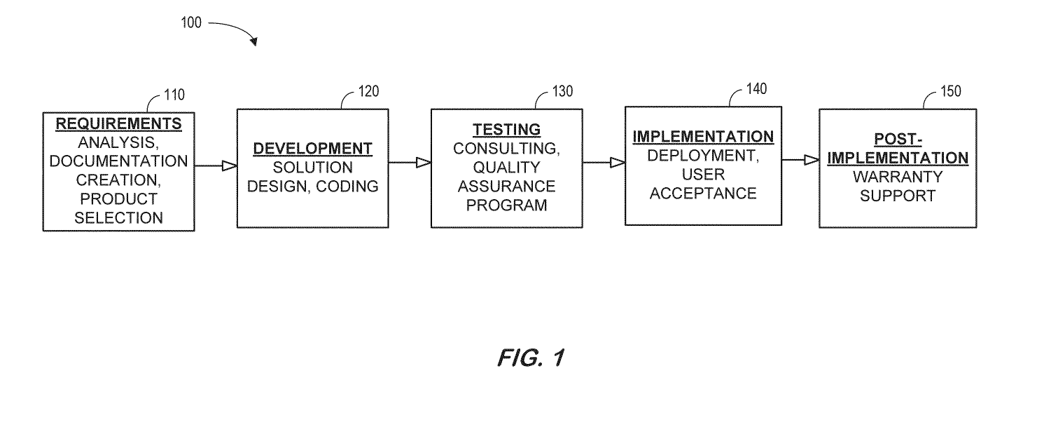

In some cases, an amount of resources associated with business project may need to be estimated. An enterprise considering an update to existing system might, for example, ask a project leader to estimate how many work hours would be required to implement the update. The project leader might make such an estimation based on prior projects he or she has worked on. The project leader might also break the project into a set of sub-projects. For example, FIG. 1 is block diagram of a business project 100 having a number of project “phases” according to some embodiments of the present invention. In particular, the business project includes a requirements phase 110 during which the project may be analyzed, documentation may be created, and one or more products may be selected (e.g., a software product need to implement the project). The project further includes a development phase 120 (including solution design and coding), a testing phase 130 (perhaps involving consulting and a quality assurance program), an implementation phase 140 (where a software update might be deployed and user acceptance might be determined), and post-implementation phase 150 (e.g., in connection with warranty support). Performing an accurate resource allocation estimate for a complex business project 100 can be a time consuming and error prone process.

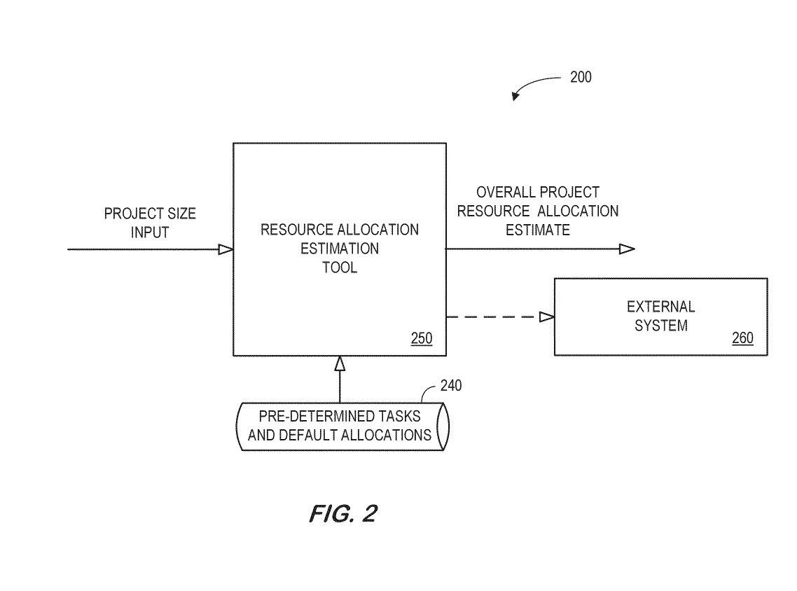

It would therefore be desirable to provide systems and methods to facilitate resource allocation estimations for a project in an automated, efficient, and accurate manner. FIG. 2 is block diagram of a system 200 according to some embodiments of the present invention. In particular, the system 200 includes a resource allocation estimation tool 250 that receives a project size input (e.g., from a project leader). The resource allocation estimation tool 250 might be, for example, associated with a Personal Computers (PC), laptop computer, an enterprise server, a server farm, and/or a database or similar storage devices. The resource allocation estimation tool 250 may, according to some embodiments, be associated with a business organization or an insurance provider.

According to some embodiments, an “automated” resource allocation estimation tool 250 may facilitate generation of an overall project estimate resource allocation. As used herein, the term “automated” may refer to, for example, actions that can be performed with little or no human intervention.

As used herein, devices, including those associated with the resource allocation estimation tool 250 and any other device described herein, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

The resource allocation estimation tool 250 may also access pre-determined task and default allocation data 240. The pre-determined task and default allocation data 240 might be associated with, for example, a type of business project and might be based on data determined in connection with past projects. The pre-determined task and default allocation data 240 may be locally stored or reside remote from the resource allocation estimation tool 250. As will be described further below, the pre-determined task and default allocation data 240 may be used by the resource allocation estimation tool 250 along with the project size input to generate an accurate overall project estimated resource allocation (e.g., how many business analyst man hours will be required to support the project). According to some embodiments, the resource allocation estimation tool 250 communicates with an external system 260, such as by transmitting estimated hours for a project to a budgeting platform, email server, workflow management system, etc.

Although a single resource allocation estimation tool 250 is shown in FIG. 2, any number of such devices may be included. Moreover, various devices described herein might be combined according to embodiments of the present invention. For example, in some embodiments, the resource allocation estimation tool 250 and pre-determined task and default allocation data 240 might be co-located and/or may comprise a single apparatus.

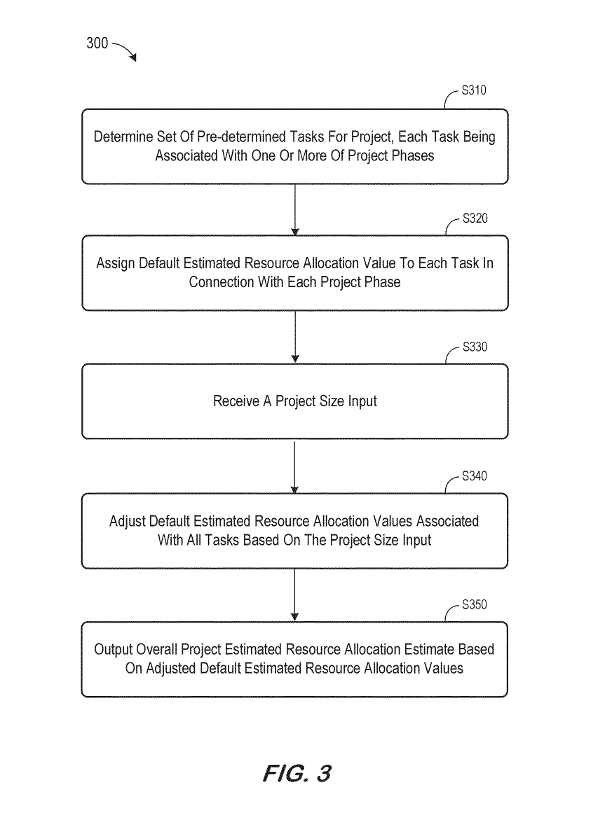

FIG. 3 illustrates a method that might be performed, for example, by some or all of the elements of the system 200 described with respect to FIG. 2 according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S310, a set of pre-determined tasks for a project may be automatically determined, each task being associated with one or more project phases. As used herein, the term project phase might refer to, for example, a preliminary analysis, requirements definition, solution design, project development, testing, implementation, post-implementation performance, and/or any other steps that might be performed in connection with a business project. Moreover, examples of “tasks” might be associated with task definition, task documentation, product selection, requirement strategy, a business requirement document, a system requirement document, a business process workflow, system use cases, a functional specification document, data source identification, data mapping, consulting, quality assurance testing, user acceptance testing, production release, warranty support and/or any other artifacts or actions that might be executed in connection with a business project. According to some embodiments, different types of projects might be associated with different tasks and/or phases (e.g., different templates).

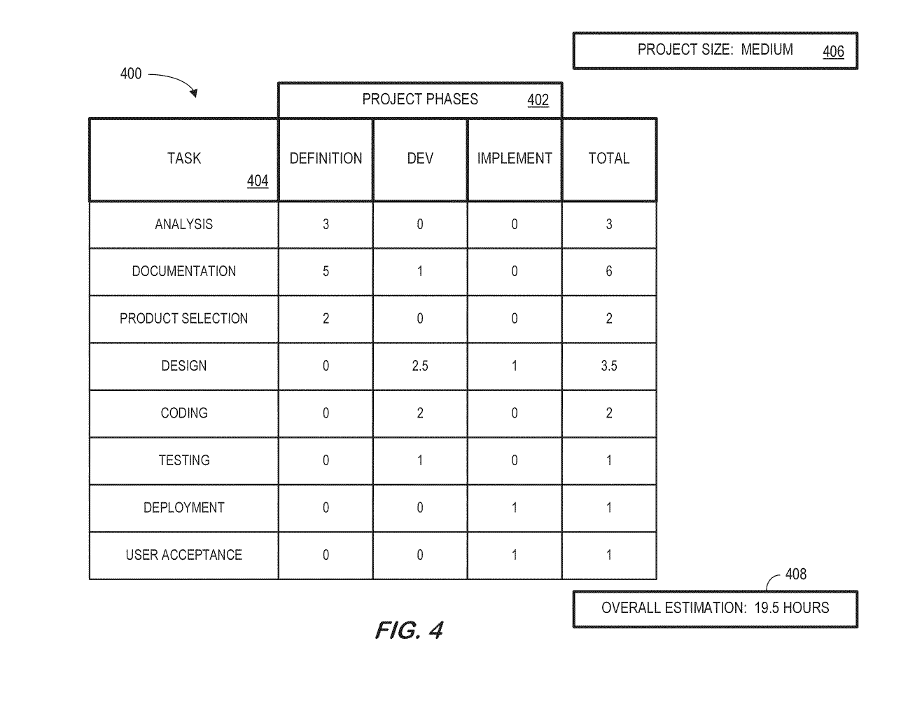

At S320, a default estimated resource allocation value is assigned to each task in connection with each project phase. The estimated resource allocation values might represent, for example, a number of work hours, monetary amounts, or business analyst resources. For example, FIG. 4 illustrates a project resource allocation estimate 400 according to some embodiments of the present invention. The estimate 400 includes three project phases 402 (definition, development, and implementation) each being associated with a number of tasks 404 (analysis, documentation, product selection, etc.). Note that the examples provided herein are solely for the purpose of illustration and actual project estimation may include hundreds of more detailed tasks.

The estimate 400 of FIG. 4 provides default work hours for each task 404 in each project phases 404. For example, 5 work hours are likely to be required to support the creation of documents during the project definition phase, 1 work hour will be needed during the development phase, and no hours are anticipated for that task during the project implementation phase. As a result, a total of 6 work hours are estimated for the documentation task. The default work hours may be associated with, for example, a “medium” sized business project 406. The hours associated with all of the tasks across all of the phases may be summed to create an overall estimation 408 of the resources that will need to be allocated for the project (19.5 hours in the example of FIG. 4). As a result, a manager may generate an accurate estimation for projects of various sizes in an intuitive manner. This can be especially helpful for large, high-dollar value IT projects such as those associated with complex financial services projects which can include many inter-related tasks, artifacts, phases, etc. (e.g., a project might include twenty or more tasks) and, as a result, can be difficult and costly to update.

A project size input may then be received at S330. For example, a project leader might select a project size from a list of “small,” “medium,” and “large” project size options. At S340, the default estimated resource allocation values associated with all tasks may be adjusted (e.g., by a spreadsheet application formula) based on the project size input. For example, the project size input might indicate that the project is smaller than an average project, in which case the adjustment may reduce default estimated resource allocation values by a pre-defined percentage amount. Similarly, the project size input might instead indicate that the project is larger than an average project, in which case the default estimated resource allocation values might increase a pre-defined percentage amount.

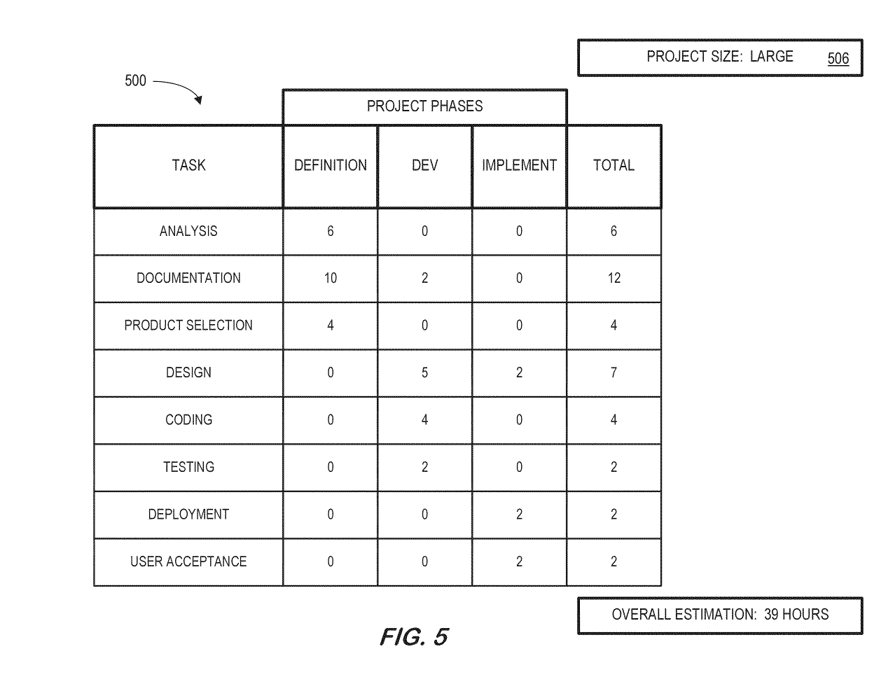

Consider, for example, FIG. 5 which illustrates a project resource allocation estimate 500 for a large sized project according to some embodiments of the present invention. Here, the project leader has changed a project size 506 from “medium” to “large.” As a result, all of the work hour estimates have been increased by 100% (doubled) and the overall estimation is 39 work hours (as compared to the 19.5 hours of FIG. 4). According to some embodiments, a medium sized project may be assigned a baseline factor of 100. In this case, a small project might be assigned a factor of 50 and a large project might be assigned a factor of 150 based on past experience performing tasks for those types of projects. According to other embodiments, project sizes of “extra small,” “extra large,” etc. may also be supported. Note that the default estimated resource allocation values might be loaded from or into a spreadsheet application, a template, a database, etc.

At S350, an overall project resource allocation estimate may be output (e.g., displayed) based on the adjusted default estimated resource allocation values for all tasks across all project phases.

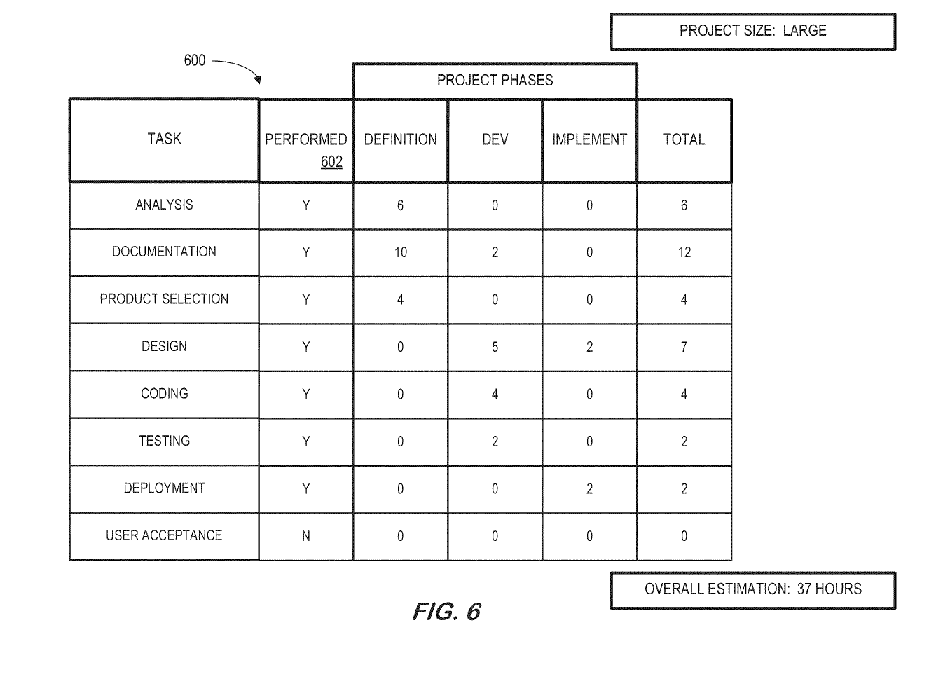

Note that different business projects may be associated with different tasks. For example, one business project may require testing while another project does not require any testing. FIG. 6 illustrates a project resource allocation estimate 600 including indications as to whether each task will need to be performed 602 according to some embodiments of the present invention. When an indication that a particular task will not be performed 602 (“N”) for the project, the resource allocation values for that task might be set in all project phases, and the overall project resource allocation estimate may be re-calculated. For example, the “user acceptance” task in FIG. 6 will not be performed and the 2 work hour estimate for the implementation phase has been replaced with “0” (as compared to FIG. 5) and the overall estimate has been reduced from 39 hours to 37 hours.

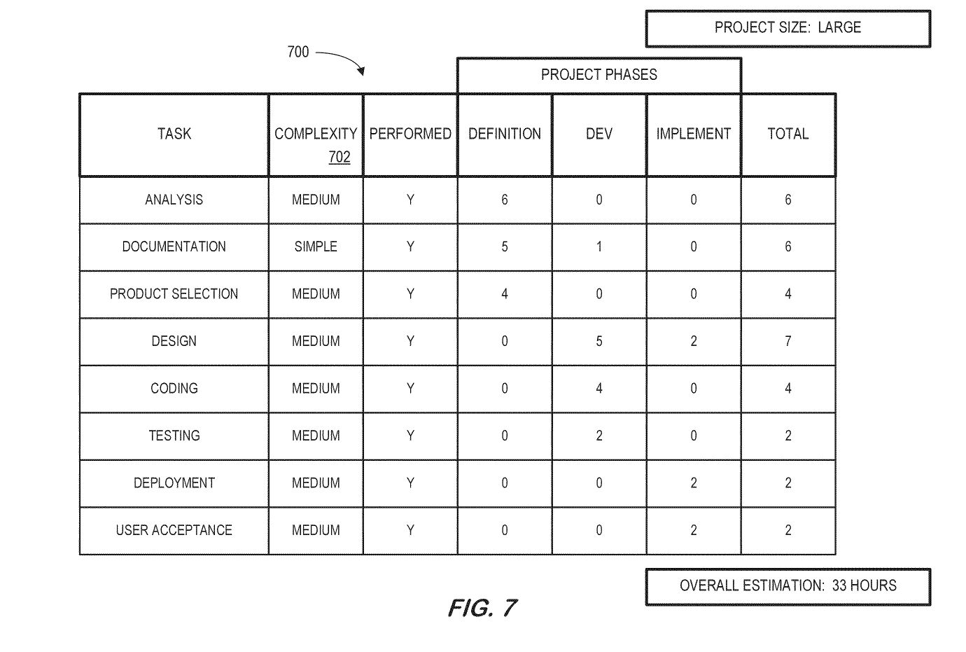

Further note that even when the same task is to be performed in different projects, the scope or complexity of the task may vary. FIG. 7 illustrates a project resource allocation estimate 700 including a task complexity input 702 feature according to some embodiments of the present invention. When a task complexity input 702 for a particular task changes, the resource allocation values for that particular task in all project phases may be adjusted (e.g., by a predetermined percentage amount) and the overall project resource allocation estimate may be re-calculated. In the example of FIG. 7, the “document task” has been assigned a complexity input 702 of “simple” (as compared to medium) and, as a result, the values for that task have been reduced by 50% (as compared to FIG. 5). The total hours for that task were charged from 12 hours to 6 hours (and the overall estimate dropped from 39 hours to 33 hours).

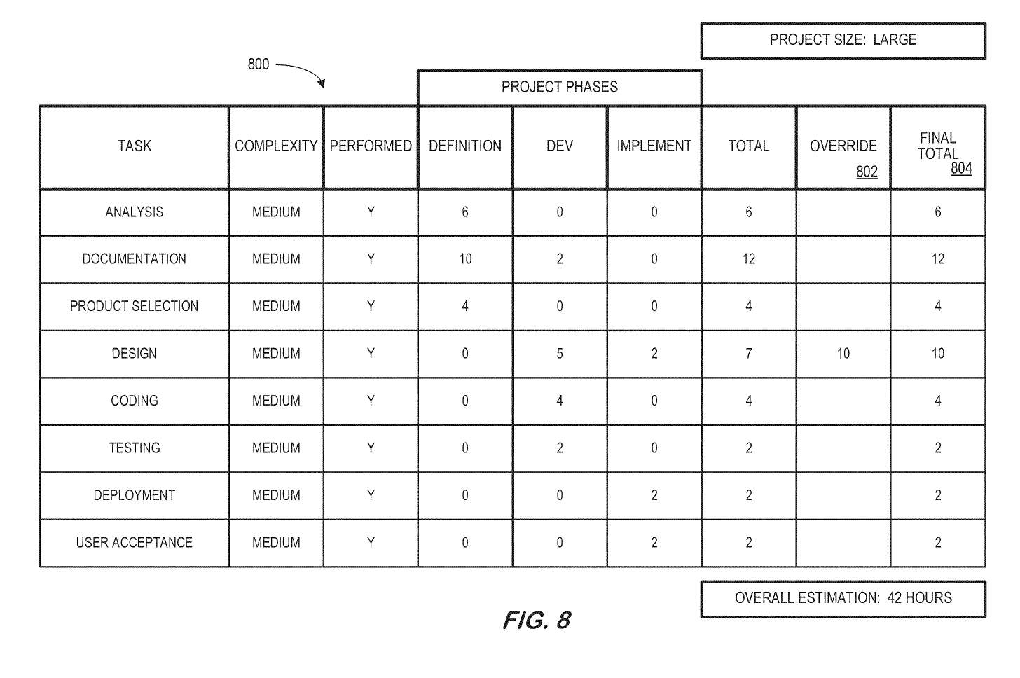

Even when the complexities of various tasks are taken into account, other factors might influence the accuracy of an estimate. For example, an employee with a lot of experience performing a particular task might perform the task much quicker as compared to other employees. FIG. 8 illustrates a project resource allocation estimate 800 including an override 802 feature according to some embodiments of the present invention. When an override 802 value is provided for a particular task, a resource allocation value for that particular task may be replaced with the override value. The overall project resource allocation estimate may then be re-calculated based on the estimated resource allocation values for all tasks across all project phases. In the example of FIG. 8, to original total of 7 hours for the “design” task (based on 5 hours in the development phase and 2 hours in the implementation phase) has been replaced with an override 802 value of 10 hours. As a result, the overall estimation has increased from 39 hours to 42 hours as compared to the example of FIG. 5.

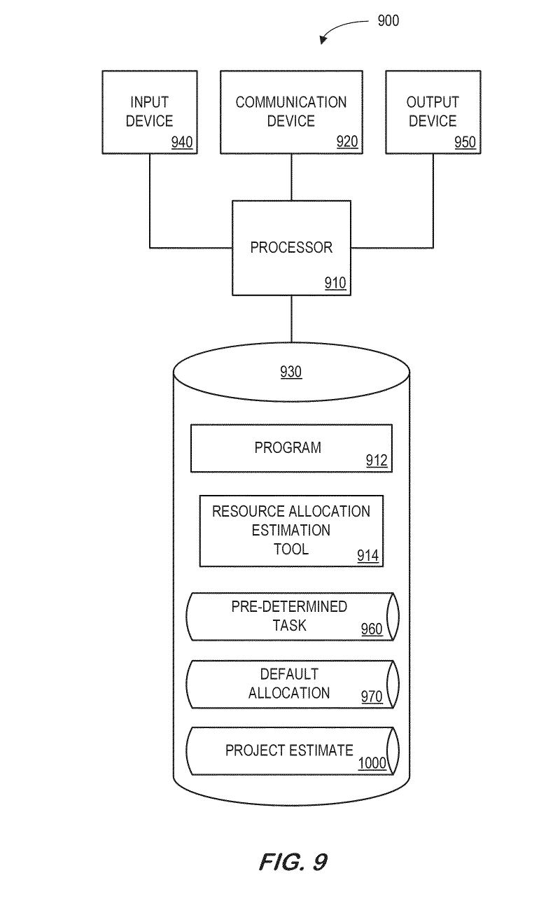

The embodiments described herein may be implemented using any number of different hardware configurations. For example, FIG. 9 illustrates a resource allocation estimation tool 900 that may be, for example, associated with the system 200 of FIG. 2. The resource allocation estimation tool 900 comprises a processor 910, such as one or more commercially available Central Processing Units (CPUs) in the form of one-chip microprocessors, coupled to a communication device 920 configured to communicate via a communication network (not shown in FIG. 9). The communication device 920 may be used to communicate, for example, with one or more remote project leader devices. The resource allocation estimation tool 900 further includes an input device 940 (e.g., a mouse and/or keyboard to enter business project information including default resource allocation estimates) and an output device 950 (e.g., a computer monitor to display estimates or reports).

The processor 910 also communicates with a storage device 930. The storage device 930 may comprise any appropriate information storage device, including combinations of magnetic storage devices (e.g., a hard disk drive), optical storage devices, mobile telephones, and/or semiconductor memory devices. The storage device 930 stores a program 912 and/or a resource allocation estimation tool 914 (e.g., associated with a spreadsheet application plug-in) for controlling the processor 910. The processor 910 performs instructions of the programs 912, 914, and thereby operates in accordance with any of the embodiments described herein. For example, the processor 910 may automatically determine a set of pre-determined tasks for the project, each task being associated with one or more of the project phases. Moreover, a default estimated resource allocation value may be assigned by the processor 910 to each task in connection with each project phase. According to some embodiments, a project size input may be received by the processor 910, and a spreadsheet application formula may automatically adjust the default estimated resource allocation values associated with all tasks based on the project size input. An overall project resource allocation estimate may then be output by the processor 910 based on the adjusted default estimated resource allocation values for all tasks across all project phases.

The programs 912, 914 may be stored in a compressed, uncompiled and/or encrypted format. The programs 912, 914 may furthermore include other program elements, such as an operating system, a database management system, and/or device drivers used by the processor 910 to interface with peripheral devices.

As used herein, information may be “received” by or “transmitted” to, for example: (i) the resource allocation estimation tool 900 from another device; or (ii) a software application or module within the resource allocation estimation tool 900 from another software application, module, or any other source.

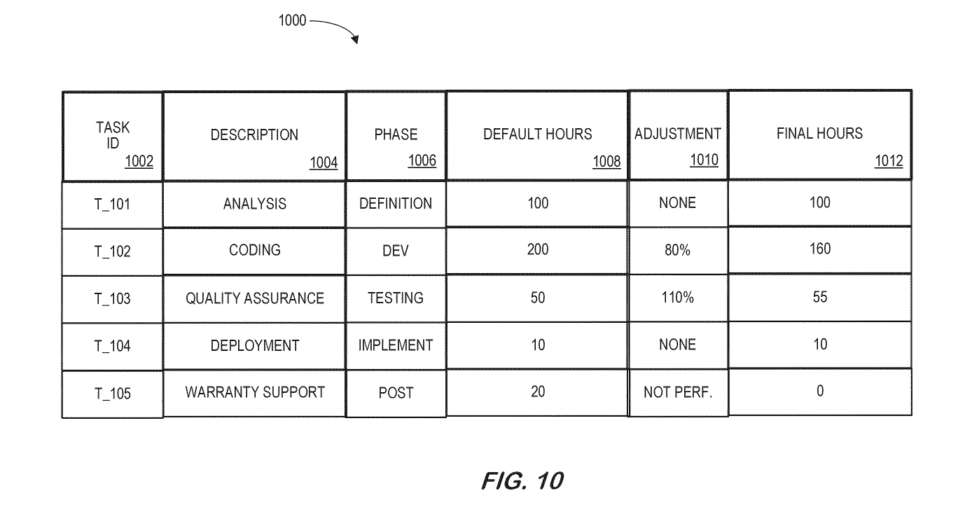

In some embodiments (such as shown in FIG. 9), the storage device 930 stores a predetermined task database 960, a default allocation database 970, and a project estimate database 1000. An example of a database that may be used in connection with the resource allocation estimation tool 900 will now be described in detail with respect to FIG. 10. Note that the database described herein is only one example, and additional and/or different information may be stored therein. Moreover, various databases might be split or combined in accordance with any of the embodiments described herein.

Referring to FIG. 10, a table is shown that represents the project estimate database 1000 that may be stored at the resource allocation estimation tool 900 according to some embodiments. The table may include, for example, entries identifying tasks that will be performed in connection with a business project. The table may also define fields 1002, 1004, 1006, 1008, 1010, 1012 for each of the entries. The fields 1002, 1004, 1006, 1008, 1010, 1012 may, according to some embodiments, specify: a task identifier 1002, a description 1004, a phase 1006, default hours 1008, an adjustment 1010, and final hours 1012. The information in the project estimate database 1000 may be created and updated, for example, based on information from a pre-determined task database, a default allocation database, and/or a project leader.

The task identifier 1002 may be, for example, a unique alphanumeric code identifying an artifact or action that may need to be performed in connection with a business project. The description 1004 may describe the task and the phase 1006 might indicate one or more phases during which the task is to be performed. The default hours 1008 might represent, for example, a typical number of hours needed to perform the task. The adjustment 1010 might indicate, for example, that the overall project is larger (or smaller) than normal, that the task is more (or less) complex than normal, or that a project leader has input an override value for the task. The final hours 1012 may represent, for example, the default hours 1008 after the adjustment 1010 has been applied. The sum of all final hours 1012 might represent, for example, an overall estimate of resources that need to be allocated for the project.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases described herein may be combined or stored in external systems).

Applicants have discovered that embodiments described herein may be particularly useful in connection with estimating a number of work hours needed from business analysts to support a business project. Note, however, that other types of interactions may also benefit from the invention. For example, embodiments of the present invention may be used in connection with construction projects, educational projects, and/or governmental projects.

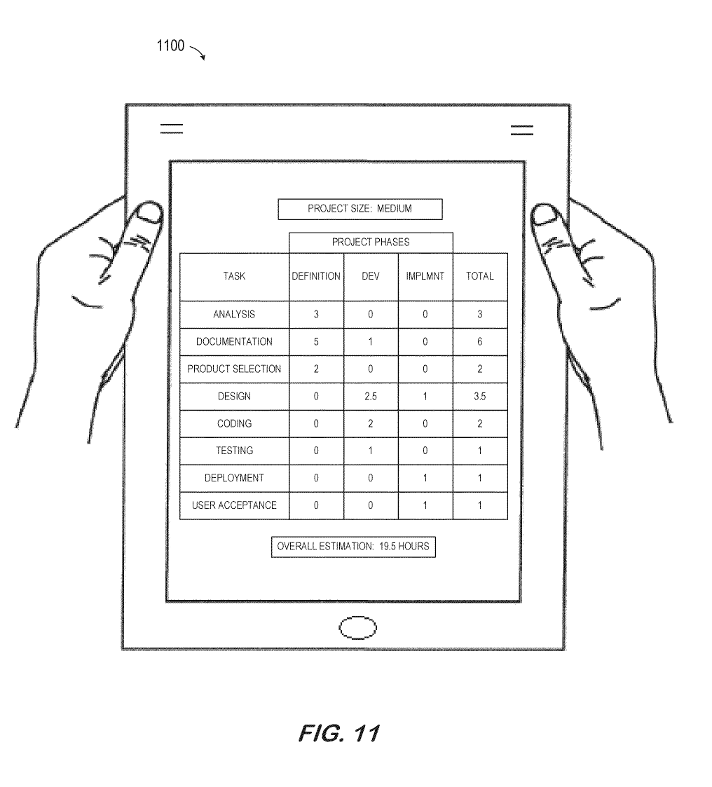

Moreover, some embodiments have been described herein as being accessed via a PC or laptop computer. Note, however, that embodiments may be implemented using any device capable of executing the disclosed functions and steps. For example, FIG. 11 illustrates a display 1100 in accordance with some embodiments described herein. In particular, the display 1100 includes a graphical user interface including information about a business projects, including estimated resource allocation values and an overall estimate for a business project.

Further, some embodiments have been described herein as having a team leader enter default resource allocation values. According to some embodiments, however, some or all of such information might be automatically generated. For example, a resource allocation estimation modeling engine might receive historical budget or human resources data (e.g., from a database). The modeling engine may then assign appropriate default values and/or adjustments (e.g., a factor to be applied to “large” sized projects) using predictive models, such as neural networks, Bayesian networks, and support vector machines, when performing these tasks.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A system associated with a resource estimation tool for a financial services related project to be performed in a series of financial services related project phases, comprising:
a communication device to receive a financial services related project size input;
a computer processor for executing program instructions; and
a memory, coupled to the computer processor, for storing program instructions for execution by the computer processor for:
automatically determining, based solely on a project type, a set of pre-determined tasks for the financial services related project from a database of pre-determined tasks, each task being associated with one or more of the financial services related project phases;
assigning, from a database of default allocations, a default estimated resource allocation value to each task in connection with each financial services related project phase;
adjusting the default estimated resource allocation value associated with each task based solely on the project size input, by applying a single pre-defined percentage amount to each default estimated resource allocation value for each task, thereby generating an adjusted estimated resource allocation value for each task; and
calculating an overall financial services related project resource allocation estimate based on the adjusted estimated resource allocation value for each task across all financial services related project phases.

2. The system of claim 1, wherein the memory further stores program instructions for execution by the computer processor for:
receiving an indication that a particular task will not be performed for the financial services related project;
responsive to the indication, setting the adjusted estimated resource allocation values to zero for the particular task in all financial services related project phases; and
re-calculating, responsive to the setting of the adjusted estimated resource allocation values to zero for the particular task in all financial services related project phases, the overall financial services related project resource allocation estimate.

3. The system of claim 1, wherein the memory further stores program instructions for execution by the computer processor for:
receiving a task complexity input comprising one of a simple complexity or a medium complexity for a particular task;
responsive to the task complexity input, adjusting the adjusted estimated resource allocation values for the particular task in all financial services related project phases by applying a single pre-defined percentage amount to each adjusted estimated resource allocation value for the particular task; and
re-calculating, responsive to the adjusting of the adjusted estimated resource allocation values for the particular task in all financial services related project phases, the overall financial services related project resource allocation estimate.

4. The system of claim 1, wherein the memory further stores program instructions for execution by the computer processor for:
receiving an override value and override justification associated with a particular task, the override value representative of an estimated resource allocation value associated with prospective performance of the particular task;
responsive to the override value, replacing the adjusted estimated resource allocation value for the particular task with the override value; and
re-calculating, responsive to the replacing of the adjusted estimated resource allocation value for the particular task with the override value, the overall financial services related project resource allocation estimate.

5. The system of claim 1, wherein the financial services related project size input is received as a user selection from a list of project sizes including small, medium, and large selections, and wherein adjusting the default allocation values associated with all tasks responsive to receipt of a small project size input comprises reducing by a spreadsheet application formula the default estimated resource allocation values associated with all tasks by the pre-defined percentage amount.

6. The system of claim 1, wherein the financial services related project size input is received as a user selection from a list of project sizes including small, medium, and large selections, and wherein adjusting the default allocation values associated with all tasks responsive to receipt of a large project size input comprises increasing by a spreadsheet application formula the default estimated resource allocation values associated with all tasks by the pre-defined percentage amount.

7. The system of claim 1, wherein at least one financial services related project phase is associated with at least one of: (i) preliminary analysis, (ii) requirement definition, (iii) solution design, (iv) financial services related project development, (v) testing, (vi) implementation, and (vii) post-implementation performance.

8. The system of claim 1, wherein the financial services related project is associated with at least twenty tasks, including at least one of: (i) task definition, (ii) task documentation, (iii) product selection, (iv) requirement strategy, (v) a business requirement document, (vi) a system requirement document, (vii) a business process workflow, (viii) system use cases, (ix) functional specification document, (x) data source identification, (xi) data mapping, (xii) consulting, (xiii) quality assurance testing, (xiv) user acceptance testing, (xv) production release, and (xvi) warranty support.

9. The system of claim 1, wherein the default estimated resource allocation values are associated with at least one of: (i) work hours, (ii) monetary amounts, or (iii) business analyst resources.

10. The system of claim 1, wherein the memory further stores program instructions for execution by the computer processor for:
receiving a level of experience input for a particular task;
responsive to the level of experience input, adjusting the adjusted estimated resource allocation values for the particular task in all financial services related project phases; and
re-calculating, responsive to the adjusting of the adjusted estimated resource allocation value based on the level of experience input, the overall financial services related project resource allocation estimate based on the estimated resource allocation values for all tasks across all financial services related project phases.

11. A computer-implemented method associated with a resource estimation tool for a project to be performed in a series of project phases, comprising:
automatically determining, by a computer processor and based solely on a project type, a set of pre-determined tasks for the project, each task being associated with one or more of the project phases;
assigning, by a computer processor, a default estimated resource allocation value to each task in connection with each project phase;
receiving, by a computer processor, a project size input;
adjusting by a computer processor, by a spreadsheet application formula based solely on the project size input, the default estimated resource allocation values associated with all tasks by applying a single pre-defined percentage to each estimated resource allocation value associated with each task; and
outputting, by a computer processor, an overall project resource allocation estimate based on the adjusted default estimated resource allocation values for all tasks across all project phases.

12. The method of claim 11, further comprising:
receiving an indication that a particular task will not be performed for the project;
responsive to the indication, setting the adjusted estimated resource allocation values to zero for the particular task in all project phases; and
re-calculating, responsive to the setting of the adjusted estimated resource allocation values to zero for the particular task in all project phases, the overall project resource allocation estimate.

13. The method of claim 11, further comprising:
receiving a task complexity input comprising one of a simple complexity or medium complexity for a particular task;
responsive to the task complexity input, adjusting the adjusted estimated resource allocation values for the particular task in all project phases by applying a single pre-defined percentage amount to each adjusted estimated resource allocation value for the particular task; and
re-calculating, responsive to the adjusting of the adjusted estimated resource allocation values for the particular task in all financial services related project phases, the overall project resource allocation estimate.

14. The method of claim 11, further comprising:
receiving an override value and override justification associated with a particular task, the override value representative of an estimated resource allocation value associated with prospective performance of the particular task;
responsive to the override value, replacing the adjusted estimated resource allocation value for the particular task with the override value; and
re-calculating, responsive to the replacing of the adjusted estimated resource allocation value for the particular task with the override value, the overall project resource allocation estimate.

15. The method of claim 11, wherein the default estimated resource allocation values are associated with at least one of: (i) work hours, (ii) monetary amounts, or (iii) business analyst resources.

16. A non-transitory computer-readable medium storing instructions adapted to be executed by a computer processor to perform a method associated with a resource estimation tool for a complex insurance financial services project to be performed in a series of project phases, the method comprising:
automatically determining, based solely on a project type, a set of pre-determined tasks for the complex insurance financial services project from a database of pre-determined tasks, each task being associated with one or more of the project phases;
assigning, from a database of default allocations, a default estimated resource allocation value to each task in connection with each project phase;
receiving a project size input;
adjusting, by a spreadsheet application formula based solely on the project size input, the default estimated resource allocation values associated with all tasks by applying a single pre-defined percentage to each default estimated resource allocation value associated with each task, thereby generating an adjusted estimated resource allocation for each task; and
outputting an overall project resource allocation estimate for the complex financial services project based on the adjusted estimated resource allocation values for all tasks across all project phases.

17. The medium of claim 16, wherein the method further comprises:
receiving an indication that a particular task will not be performed for the complex financial services project;
responsive to the indication, setting the adjusted estimated resource allocation values to zero for the particular task in all project phases; and
re-calculating, responsive to the setting of the adjusted estimated resource allocation value to zero for the particular task in all financial services related project phases, the overall project resource allocation estimate.

18. The medium of claim 16, wherein the method further comprises:
receiving a task complexity input comprising one of a simple complexity or a medium complexity for a particular task;
responsive to the task complexity input, adjusting the adjusted estimated resource allocation values for the particular task in all project phases by applying a single pre-defined percentage amount to each adjusted estimated resource allocation value for the particular task; and
re-calculating, responsive to the adjusting of the adjusted estimated resource allocation values for the particular task in all financial services related project phases, the overall project resource allocation estimate.

19. The medium of claim 16, wherein the method further comprises:
receiving an override value and override justification associated with a particular task, the override value representative of an estimated resource allocation value associated with prospective performance of the particular task;
responsive to the override value, replacing the adjusted estimated resource allocation value for the particular task with the override value; and
re-calculating, responsive to the replacing of the adjusted estimated resource allocation value for the particular task with the override value, the overall project resource allocation estimate.

20. The medium of claim 16, wherein the default estimated resource allocation values are associated with at least one of: (i) work hours, (ii) monetary amounts, or (iii) business analyst resources.
